(19) United States
(12) Patent Application Publication
(10) Pub. No.: US 2009/0184822 A1
(43) Pub. Date: Jul. 23, 2009

(54) SECURITY APPARATUS WITH IDENTIFICATION MECHANISM

(75) Inventors: Robert Mahaffey, Vancouver (CA); John Hung, Vancouver (CA); Guillermo Andres, Pleasanton, CA (US); Samson Lee, Vancouver (CA); Will Ali, Vancouver (CA); Wilson Tse, Vancouver (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACCO Brands USA LLC, Lincolnshire, IL (US)

(21) Appl. No.: 12/338,664

(22) Filed: Dec. 18, 2008

Related U.S. Application Data
(60) Provisional application No. 61/016,271, filed on Dec. 21, 2007.

(51) Int. Cl. G08B 13/14

(52) U.S. Cl. 340/568.1

(57) ABSTRACT

A security system is disclosed. Embodiments of the system comprise a key containing a unique identifier, and a security device capable of reading the unique identifier from the key. In certain embodiments the unique identifier is stored on an integrated circuit within the key along with a power supply for the security device. Use of the proper key can initiate the locking or unlocking of the security device, through actuating means.

### CROSS-REFERENCES TO RELATED APPLICATIONS

This patent application is a non-provisional of and claims priority to U.S. provisional patent application No. 61/016,271, filed on Dec. 21, 2007, which is herein incorporated by reference in its entirety for all purposes.

### BACKGROUND

Traditionally, portable electronic devices, such as portable computers, have been secured by systems employing a cable to attach the devices to a relatively immovable object such as a desk.

Physical security devices use mechanical keys to lock or unlock a lock head that can be secured to a portable electronic device. While the use of mechanical keys is acceptable, improvements could be made. For example, mechanical keys are relatively easy to reproduce. If a mechanical key is reproduced, then security may be compromised.

Embodiments of the invention address these and other problems, individually and collectively.

### BRIEF SUMMARY

Embodiments of the invention are directed to security devices, as well as systems and methods for using such physical security devices.

Another embodiment of the invention is directed to a security device for use with a portable electronic device having a housing and an aperture, the security device comprising: a sensor configured receive at least one identifier stored in a key; a controller coupled to the sensor; an actuating member operatively coupled to the controller, wherein the actuating member is configured to actuate after receiving an unlock signal from the controller; and at least one of a stabilizing element and an engagement member, wherein the actuating member is capable of selectively operatively coupling to the stabilizing element or the engagement member.

Another embodiment of the invention is directed to a method comprising: obtaining a security device comprising a housing, and a sensor, at least one of a stabilizing element and an engagement member, and a controller coupled to the housing; inserting at least a portion of the engagement member into an aperture in a portable electronic device housing, thereby securing the security device to the portable electronic device housing; placing a key proximate to the sensor; moving one or more of the engagement member or the stabilizing element; and separating the security device from the portable electronic device housing.

These and other embodiments of the invention are described in further detail below with reference to the Figures and the Detailed Description.

### BRIEF DESCRIPTION OF THE DRAWINGS

FIG. 1 shows a system according to an embodiment of the invention.

FIGS. 2A-2B show rear views of a security device and corresponding key, according to an embodiment of the invention.

FIG. 3 shows a front view of a security device and corresponding key, according to an embodiment of the invention.

FIG. 4A shows a block diagram detailing a method according to an embodiment of the invention.

FIGS. 4B-1 and 4B-2 respectively show locking heads in a locked state and unlocked state.

FIG. 5 shows a block diagram of an embodiment of a security device.

FIG. 6 shows a state diagram of a security device according to an embodiment of the invention.

FIG. 7 shows an expanded view of an embodiment of a security device.

FIG. 8 shows a cross-sectional view of the security device of FIG. 7.

FIG. 9A-9B show cross-sectional views of an embodiment of a security device.

FIG. 10A-10B show cross-sectional views of an embodiment of a security device.

FIG. 11A-11B show cross-sectional views of an embodiment of a security device.

FIG. 12A-12B show cross-sectional views of an embodiment of a security device.

FIG. 13A-13B show cross-sectional views of an embodiment of a security device.

FIG. 14A-14B show cross-sectional views of an embodiment of a security device.

FIGS. 15A-15C show embodiments of circuit diagrams of a security device and key.

In the figures, like numerals designate like elements, and the descriptions of like elements may not be repeated in some instances.

### DETAILED DESCRIPTION

Embodiments of the invention are directed to security devices, methods for using security devices, and systems using such security devices. The security devices can be used to prevent or deter the theft of portable electronic devices.

One embodiment of this invention is directed towards a security apparatus that comprises a security device and a corresponding key. The security device is configured to secure a portable electronic device to a stationary object such as a desk. It can have a slot engagement member such as a bar including a T-bar. The engagement member can engage a portable electronic device via a slot in a housing in the portable electronic device. The engagement member in the security device is selectively operatively coupled to an electric motor or other suitable actuating device. That is, the actuating device can be physically coupled to the engagement member at specific moments, such as to unlock the security device. While the security device is in a locked configuration, the actuating device may not be operatively coupled to the engagement member, as will be described in greater detail below. The actuating device is designed to only activate (i.e., operatively couple to the engagement member), after a sensor electrically coupled to the motor receives at least one identifier from a key that is being used by the user. In an exemplary embodiment, the at least one identifier is stored in digital form on an integrated circuit that is present in a key. The at least one identifier may include only one, or at least two, or even at least three or more identifiers.

Once the sensor in the security device is proximate to the key or is otherwise operatively coupled to it, the integrated circuit in the key sends the at least one identifier to the sensor in the security device. If the at least one identifier is associated with the security device, the actuating member actuates so that it is selectively, temporarily and operatively coupled to the key. In one embodiment, the actuating member is operatively coupled to the key in a manner that allows the user to move the engagement member when the user moves the key. For example, when the actuating member and the key are operatively coupled together, the user can rotate the engagement member by rotating the key. This allows the user to configure the security device in a locked or unlocked configuration.

The portable electronic device to be secured may comprise an aperture, and the aperture may be a through aperture or a blind aperture. The aperture may be formed in a housing associated with the portable electronic device. The aperture can have any suitable dimensions, such as about 3 millimeters (mm) by about 7 mm. This aperture can receive and couple with the engagement member of the security device. Alternatively or additionally, the portable electronic device may include a lock interface member, and the lock interface member may comprise the aperture. The lock interface member may be used to enhance security and may improve the strength of the coupling between the portable electronic device and the security device. The lock interface member may be an attachment that may be attached to the housing of the portable electronic device, or it may be integrally formed in the housing. For example, in some embodiments, the lock interface member may be operatively or physically coupled to the chassis of the portable electronic device and/or may be operatively or electrically coupled to some electrical component in the portable electronic device. Exemplary lock interface members are described in U.S. Provisional Patent Application Nos. 60/853,888, filed on Oct. 23, 2006, 60/909,867, filed on Apr. 3, 2007, and 60/940,318, filed on May 25, 2007, as well as PCT Application Nos. PCT/US07/76884, PCT/US07/82139, and PCT/US07/82134, all filed on Oct. 22, 2007, which are herein incorporated by reference in their entirety for all purposes.

A security device according to an embodiment of the invention may comprise a head and a cable. The head and the security cable may be physically and/or operationally coupled together.

The security device may comprise a cable as described above, or some other type of mechanism to provide security. If the security device comprises a cable, then the cable may be secured to an object other than the security device or portable electronic device, such as a stationary object. The stationary object can comprise objects such as a desk or cabinet so that a portable electronic device coupled to the cable cannot be removed. In another embodiment, the security device may comprise a wireless communicator such as a wireless transmitter and/or receiver in place of, or in addition to, the security cable. The wireless communicator may be used in a proximity detection system or a motion detection system. For example, a motion detector could present in the wireless communicator so that when the motion detector moves, an associated alarm is triggered. The alarm may be in the security device or may be external to the security device. In another embodiment, there may be a base device associated with the wireless communicator, and these components may be used in a proximity detection system. Wireless signals may be transmitted between the security device and the base device, and when these devices are separated by a predetermined length, an associated alarm (e.g., an audible alarm) may be triggered. The alarm could be in the base device or in the security device.

The head may be a locking head. A locking head according to an embodiment of the invention may comprise a locking mechanism such as an electronic key locking mechanism or a combination locking mechanism disposed within it.

The portable electronic device that is to be secured by the security device may comprise any suitable portable electronic device. Examples of such portable electronic devices comprise boxes, bags such as laptop bags or backpacks, or portable electronic devices such as portable computers, printers, flat panel televisions and monitors (small and large), projectors, external hard-drives, portable media devices, smartphones, etc., or any combination thereof.

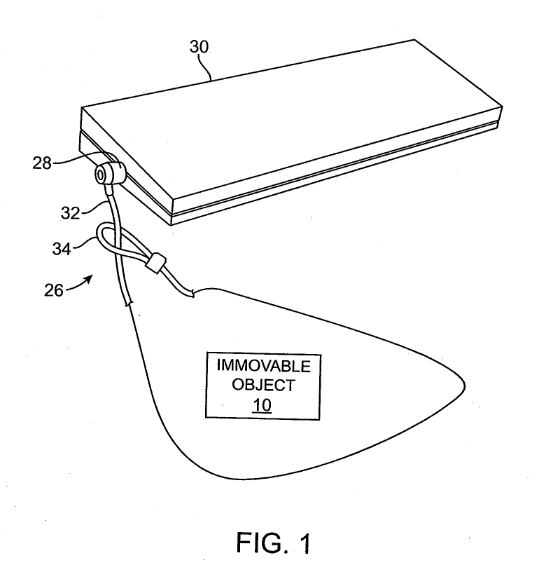

FIG. 1(a) shows an embodiment of a system comprising a portable electronic device 30 and a security device 26 that is used to secure the portable electronic device 30 to a stationary object 10 such as a desk leg or the like. The security device 26 comprises a head 28 and a security cable 32. The cable 32 is coupled to the head 28, which may be a locking head in this example. A loop 34 is at a terminal end of the cable 32. The cable 32 may comprise a strong material such as stainless steel or Kevlar™.

To secure the portable electronic device 30 to the stationary object, the cable 32 may be wrapped around the stationary object and the head 28 may pass through the loop 34. An engagement member (e.g., a slot engagement member) in the head 28, or at least a portion of the engagement member, may then be inserted into a security slot comprising an aperture in the portable electronic device 30, or in an aperture in a lock interface member (not shown) that is associated with the portable electronic device 30. The head 28 may also comprise at least one stabilizing element (e.g., a pin). The stabilizing element may be inserted, concurrently with the slot engagement member, into the security slot or to stabilize the head 28, so that the engagement member cannot be readily withdrawn from the aperture. In some embodiments, the slot engagement member may be in the form of a T-bar. The stabilizing element may comprise one or more anti-rotation pins. A locking mechanism such as an electronic key locking mechanism in conjunction with an actuating member may be used to keep the stabilizing element and/or the slot engagement member from moving or not moving. In other embodiments, the stabilizing element may first be inserted into the aperture in the lock interface member, and/or an aperture in the portable electronic device, and the slot engagement member may thereafter be inserted therein to engage the aperture in the portable electronic device or in the lock interface member. In a further embodiment, the slot engagement member may first be inserted into the aperture in the lock interface member and/or an aperture in the portable electronic device to engage the aperture, and the stabilizing element may thereafter be inserted in the portable electronic device or in the lock interface member.

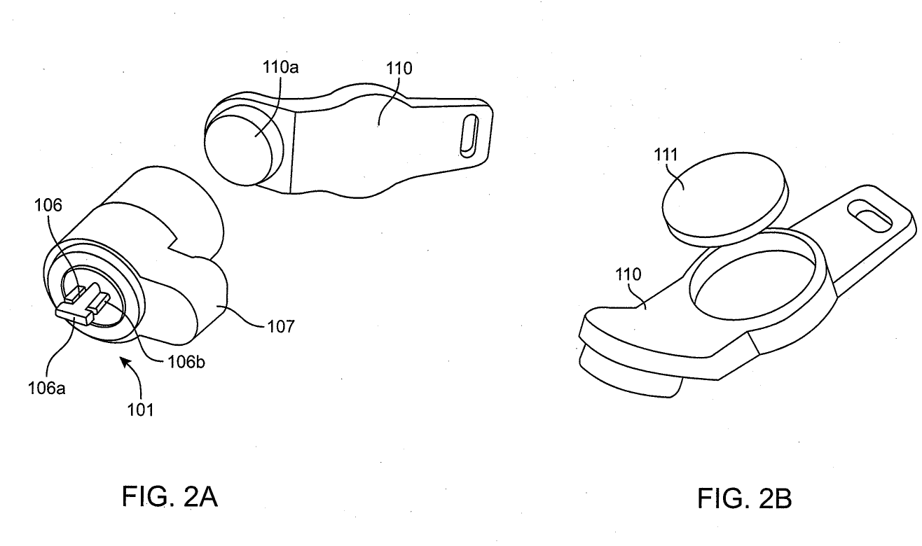

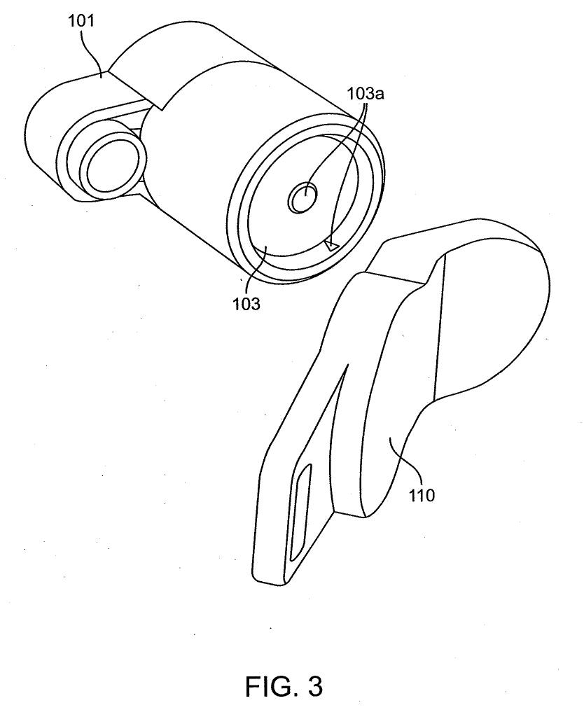

Specific security device embodiments are shown in FIGS. 2A-14B.

FIG. 2A shows a security device 101 according to an embodiment of the invention. Security device 101 comprises an engagement member 106. Engagement member 106 may include a T-bar 106a, and one or more anti-rotation pins 106b disposed on opposite sides of the engagement member 106. The T-bar 106a may comprise a shaft and a cross-member perpendicular to the shaft. The pins 106b may be examples of stabilizing elements. Exemplary embodiments include at least one of a stabilizing element and an engagement member. T-bar 106a and anti-rotation pins 106b may be aligned so that the security device 101 is in an unlocked configuration (as shown in FIG. 2A). Engagement member 106 can engage an aperture such as a security slot in a housing of a portable electronic device. Cable connector 107 connects the security device 101 to a cable (not shown) that can be present in the security device 101.

Components in the security device 101 can be activated by the key 110. The key 110 may comprise a memory (such as a non-volatile memory) for storing one or more identifiers. The memory may be embodied by an integrated circuit in some embodiments.

In FIG. 2A, the integrated circuit, which may be present in a container 110(a), may store a unique identifier. The container 110(a) may be in the form of a “button.” The button may comprise a 16 mm thick stainless steel cylindrical container and an integrated circuit chip inside of the container. The container 110(a) is commercially available from Maxim Integrated Products under the tradename iButton®. The data in the iButton® can contain a unique identifier such as a serial number.

As shown in FIG. 2B, key 110 also contains a power source 111, such as a battery. In some embodiments, the power supply provides power to the security device 101 when the key 110 is proximate (e.g., close to or in contact with) to the security device 101.

FIG. 3 shows a front view of security device 101. Engagement socket 103, residing in security device 101, is capable of receiving key 110. Engagement socket 103 includes a sensor 103a that receives the data within integrated circuit in the container 110a. In embodiments where container 110a is an iButton®, the engagement socket 103 will comprise an “iButton® sensor.” If the data stored in the integrated circuit in the container 110a comprises the correct identifier, an unlock signal is sent to an actuating member (not shown), which may be a direct current (DC) motor within security device 101. The unlock signal may cause the actuating member to actuate. The actuating member may actuate and may produce a mechanical force. The movement produced by the actuating member may involve a rotational, linear, or lateral motion. In certain embodiments, the actuation may comprise having the actuating member rotate all or a portion of engagement member 106. In other embodiments, the actuating member may extend or retract the anti-rotation pins 106b. In exemplary embodiments, the actuating member may operatively couple the engagement member 106 to the key 110 such that movement of the key 110 causes the engagement member 106 to move. Rotation of the key 110 (such as by a user) can cause the T-bar 106a to rotate by an equivalent amount, thereby allowing the security device 101 to be in a locked or unlocked configuration. When the user separates key 110 from engagement socket 103, the actuating member can actuate again. The actuating member can separate from the engagement member (e.g., T-bar) or stabilizing element (e.g., pins), so that rotation of the end of the security device 101 (e.g., by an unauthorized key or device) will not move the engagement member 106 or the pins 106b. At this point, the security device 101 is in a locked configuration.

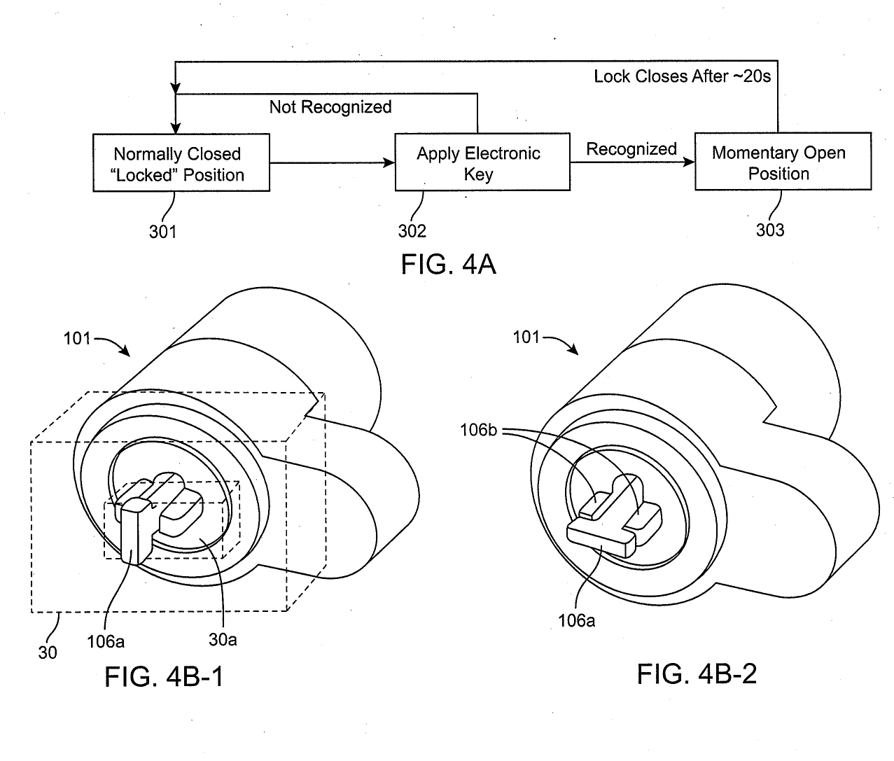

FIG. 4A shows a block diagram detailing a method of using a security device according to an embodiment of the invention. In step 301, the security device 101 is in the closed, “locked” configuration. In exemplary embodiments, the security device will remain in the closed, locked configuration at all times, other than when a key containing a proper identifier is proximate to the security device 101. The closed, locked configuration is illustrated by the vertical orientation of the cross-member of the T-bar 106a in FIG. 4B-1. The cross-member of the T-bar 106a is misaligned with the anti-rotation pins 106b so that the T-bar 106a of the security device 101 cannot be removed from the aperture 30a. The closed configuration allows the security device 101 to be secured to an aperture 30a within a housing 30 of a portable electronic device (not shown). The security device 101 cannot be separated from the portable electronic device without damaging the housing 30.

Referring again to FIG. 4A, in step 302, key 110 (see FIG. 3), is placed proximate to the security device 101. In this step, the container 110b with the integrated circuit is inserted within the engagement socket 103, so that integrated circuit in the container 110a can pass the unique identifier to the sensor 103a. In some embodiments, energy is supplied from the power source 111 (see FIG. 2B) in the key 110 to components in the security device 101, thereby allowing the sensor 103a (see FIG. 3) to receive a signal from the integrated circuit in the container 110a. This signal may contain the unique identifier stored in key 110.

A controller (not shown) in the security device 101 receives the unique identifier from the sensor 103a. The controller determines if the unique identifier that is received matches one that is stored in a memory in the security device 101. If the unique identifier that is received is not recognized by the controller, the actuating member (not shown) in the security device 101 does not actuate and the security device 101 remains in the locked configuration. If the unique identifier that is received by the controller is the correct one, the actuating member is actuated in step 303, and the security device 101 is in an open, unlocked configuration.

In some embodiments, the actuating member rotates components inside of the head of the security device so that it is in the open configuration. In other embodiments, a user can rotate the engagement member (while the actuating member is activated) by rotating the key, to configure the security device 101 so that it is in the unlocked configuration. The unlocked configuration is shown by the substantially horizontal position of the cross-member of the T-bar 106a in FIG. 4B-2. In the unlocked configuration, the T-bar 106a of the security device 101 can be inserted into or removed from an aperture in a portable electronic device. In certain embodiments, the actuating member itself is powered by the power supply on the key, which transmits power to the security device 101 via the engagement socket. In one implementation, the actuating member is actuated so that is it in an unlocked configuration for a predetermined time, after which the security device will automatically revert back to the locked configuration. In other implementations, the security device 101 can be in the open (i.e., unlocked) configuration as long as the key 110 is proximate to the engagement socket 103.

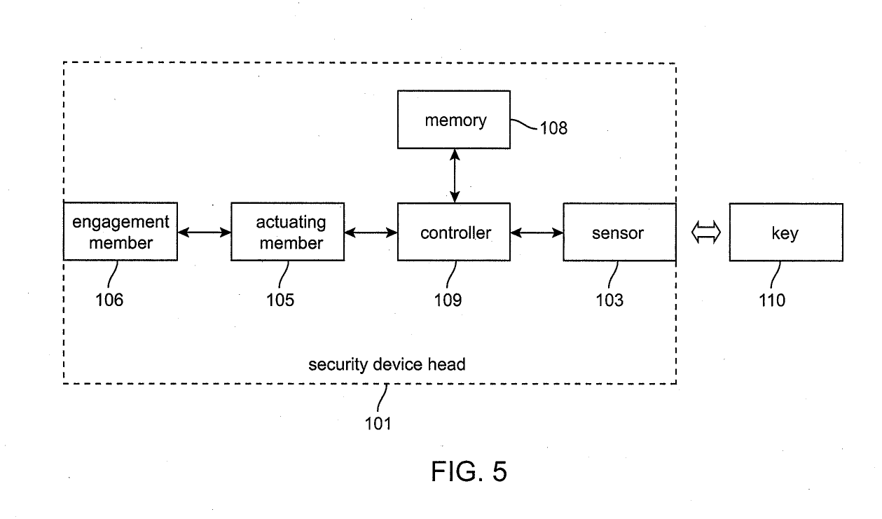

FIG. 5 shows a block diagram of a security device 101 and an associated key 110, according to an embodiment of the invention. The security device 101 may include a sensor 103 electrically coupled to a controller 109. The sensor 103 can read a unique electronic identifier from the key 110, to determine if the key 110 is properly associated with the security device 101. The sensor 103 can send the electronic identifier that is received from the key 110 to the controller 109. The controller 109 can compare the received identifier to a registry, or list, of predetermined identifiers stored in the memory 108. The list of predetermined identifiers stored in memory 108 can include those identifiers that will work with security device 101. Thus, in one aspect, if a key 110 contains any of the predetermined identifiers that are stored in the memory 108, then the key 110 can lock or unlock the security device 101. Once a proper key has been determined by the controller 109, an unlock signal can be sent by controller 109 to the actuating member 105. The actuating member 105 is then electrically or mechanically connected to an engagement member 106, such that the engagement member 106 can move. Moving the key 110 can also cause the engagement member 106 to move so that the security device 101 is in a locked or unlocked configuration.

The controller 109 can be a microprocessor that is located within the body of the speaker device. The controller is 109 electrically coupled to memory 108, which may comprise one or more volatile or non-volatile memory devices such as ROM, EEPROMs, etc. Memory 108 may store code for one or more identifiers, and code for performing any of the functions performed by the security devices and systems described herein, some or all of which may be implemented or executed by controller 109. The memory may also include computer readable media. Examples of computer readable media include magnetic, electronic, or optical disks, chips, etc. The identifier may also be written in any suitable computer programming language including C, C++, etc.

In certain embodiments, the memory may be programmed by the manufacturer of the security device. In exemplary embodiments, the memory can be programmed by a user or administrator, allowing for unique identifiers for keys to be at any time added to or removed from a list of identifiers for keys usable with the individual security device.

Although separate functional blocks are shown in FIG. 5, it is understood that one functional block may be embodied by two or more actual physical components, or two or more functional blocks may be embodied by a single physical component. For example, the sensor 103, controller 109 and the memory 108 may be integrated into one package or chip. In another example, the memory 108 may be embodied by two or more memory chips or the like.

Embodiments of security devices can store multiple key identifiers (i.e., unique electronic identifiers), and can be reprogrammed to add further key identifiers or remove existing stored key identifiers. This allows a user to replace any lost keys with a new key that can be “added” to the security device. Also, a company or other group may provision many security devices for its employees. The electronic nature of the keys and security devices in embodiments of the invention allow an administrator to maintain greater control over large device groupings. The administrator can provision keys to work with any number of security devices, and may control “prime keys” that can be used to program security devices, or for other purposes, as will be described in greater detail below.

In one implementation, a security device as described herein can include a secret algorithm so that the unique electronic identifier of a key is protected. Instead of reading the identifier from the key, the sensor in the security device can read an identifier from the key that serves as a public challenge. On reading this identifier, the security device can compute the correct response, and transmit this response back to the key. The correct response is the password to access the unique electronic identifier. Upon receiving this response/password, the key transmits its unique electronic identifier. This arrangement can provide enhanced security as it deters unauthorized duplication of keys. The duplicator would need to access the key twice to fully duplicate it, which can take longer and be more difficult to fraudulently copy.

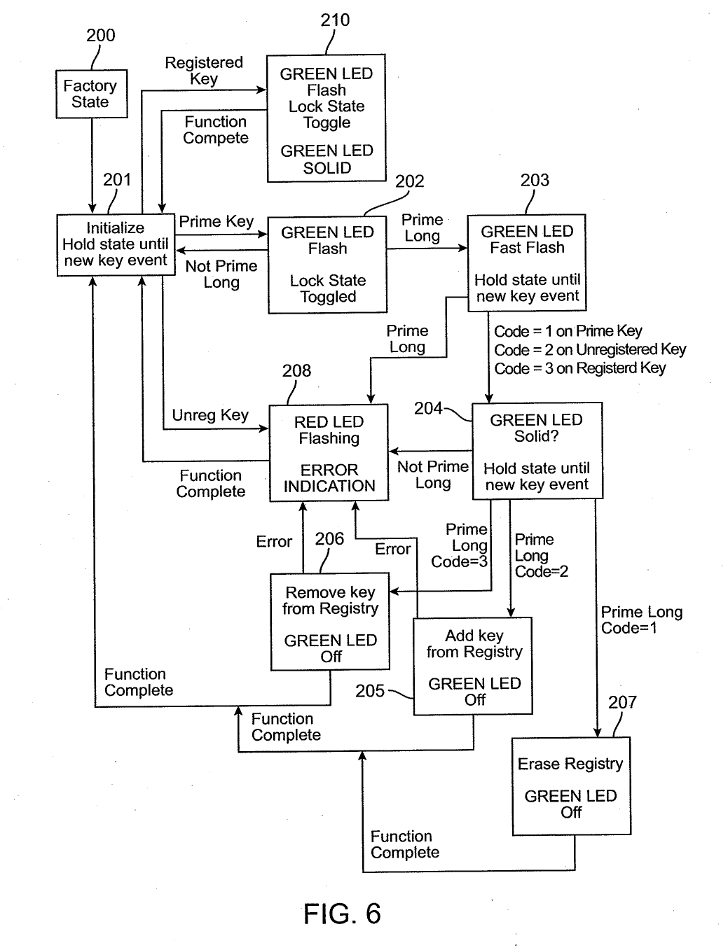

Referring to FIG. 6, a state diagram of a security device according to embodiments is shown. The security device in the embodiment of FIG. 6 can be used with multiple keys. Each key can be separately produced, and can contain a key identifier (an example of a “unique electronic identifier”) that can be read by the security device. No two keys will share the same unique electronic identifier. In certain embodiments, the security device records, in the device memory, the state the security device is currently in, and upon removal of the key, the security device powers down. In some implementations, the security device itself has no power supply and can only be powered on when in contact with a key containing a power supply.

Once the security device is manufactured, it can be in the factory state 200. In the factory state 200, no key identifiers have yet been stored in the memory of the security device. A key can then be placed proximate to the sensor in the security device. The security device can read the key identifier from the key and can add it to the registry in the security device memory. As this is the first key registered with the security device, this key will be the “prime key”. It can be used to program the security device to accept other keys, and to program the security device to remove other keys from the key registry. In exemplary embodiments, the prime key is structurally the same as any other key that is used with the security device. In these embodiments, the only difference between a prime key and the other keys is that the prime key is designated “prime” within the memory of the security device.

After a first key has been registered with the security device as a prime key, the security device can remain in the initialized state 201 until the next event occurs. The initialized state can be the default state for a security device that has been registered with a prime key, and it is the state that most security devices will be in. In this state, another key can be added to or removed from the key registry (as a user key), or the prime key can be used to lock/unlock the security device. For example, the prime key can be used to unlock the device by placing the prime key proximate to the security device, thereby operationally coupling the key and the security device. In certain embodiments, the prime key can contact the sensor in the security device for less than 3 seconds (i.e., a “tap”). The security device can enter state 202, whereby the security device will temporarily be unlocked. After unlocking, the security device can then revert back to the initialized state 201, to await the next command.

If the prime key is instead used with a special gesture rather than the tap, the security device will enter state 203. This “special gesture” is recognized as a separate signal by the security device, and can be used by the prime key to configure the security device. The special gesture can comprise, for example, holding the prime key against the sensor of the security device for 3 or more seconds. If a user performs the special gesture with the prime key (in one embodiment, a “prime long” contact), the lock enters state 203. In exemplary embodiments, the security device can indicate that it is in state 203. For example, the security device may quickly cause an attached LED to flash, it may cause a small screen such as an LCD readout to display something unique, it may provide an audible indication such as a beep or consecutive beeping, etc. At any time, an unexpected key engaged with the security device can cause the security device to abort the process. The security device may temporarily alert the user to an error in state 208, for example by flashing a red LED. This may only last for a few seconds, after which the security device can return to state 201.

In state 203, the user has several options. For example, the user may add another key to be used with the security device. This key can be a “user key”, and may only be usable to lock/unlock the security device (i.e., it will not have the operational capability of a prime key). To add a new key to be used with the security device, this key can be engaged with the security device while the security device is in state 203. If the security device is powered down when not in contact with a key, the security device will power up and recognize that it has been put in the introduction/removal mode, in state 204. The security device will record the key identifier of the new key in the security device memory. The security device may then indicate it has finished processing, for example, by have an LED produce a solid green color for a period of time. The user can then remove the new key from the security device. In certain embodiments, the new key may only need to be engaged with the security device for a “tap”, i.e. for less than 3 seconds. The prime key can then be engaged with the security device to confirm the introduction of the new key in state 205. In certain embodiments, the prime key can be engaged with the security device using the special gesture. The security device can then add the new key identifier to the key registry, and provide confirmation of such in state 205, for example by turning off the LED. Once the prime key is disengaged from the security device, the security device will revert back to the initialized state 201, to await the next command. The new key will now be usable with the security device.

In certain implementations, if a user key is used in place of the prime key in the introduction process described above, the new key may be registered as a “guest key”. This guest key may function similarly to a user key, except the guest key can only be used to engage the security device a predetermined number of times (for example, it can unlock the device 5 times). After the predetermined number of operations has been used, the security device can automatically remove the unique electronic identifier associated with the guest key from memory. Thus, the guest key will no longer be able to lock or unlock the security device.

From state 203, a user may also remove a key from the registry. To remove the key so that it cannot be used with the security device, this key can be engaged with the security device while the security device is in state 203. If the security device is powered down when not in contact with a key, the security device can power up and recognize that it has been put in the introduction/removal mode, in state 204. The security device can record the key identifier of the key, in the security device memory. The security device may then indicate it has finished processing, for example by having an LED produce a solid green color. The user can then remove the new key from the security device. In certain embodiments, the key may only need to be engaged with the security device for a “tap”, i.e. for less than 3 seconds. The prime key can then be engaged with the security device to finish the removal of the key in state 206. In certain embodiments, the prime key will be engaged with the security device using the special gesture. The security device can then compare the recently read key identifier with the list of key identifiers in the key registry stored in memory. Since this key identifier is the same as a listing in the registry, the security device can remove the listing from the registry, such that the key will no longer be usable with the security device. The security device can confirm it has removed the key from the registry in state 206, for example by turning off the LED. Once the prime key is disengaged from the security device, the security device will revert back to the initialized state 201, to await the next command. In certain implementations, only a user key can be removed from the registry, for security reasons. To reset the security device to the factory state (i.e., remove the prime key) in these implementations, the security device may be required to connect to another machine, such as a general purpose computer or a special purpose system. In other implementations, any key may be removed from the registry according to the above-described method, including prime keys.

From state 203, a user may also erase the entire key registry. This can erase every stored unique electronic identifier associated with a user key, so that the only key(s) that will still be usable with the security device are the prime key(s). To erase the entire key registry, from step 203 the prime key will be engaged with the security device. In certain embodiments, the prime key will only need to “tap” the security device for this. Such engagement will set the security device to introduction/removal state 204, and the security device will record in the memory that the prime key was just engaged with the security device. The security device may then indicate it has finished processing, for example by having an LED produce a solid green color. The prime key can then again be engaged with the security device to finish the erasure of the key registry in state 207. In certain embodiments, the prime key can be engaged with the security device using the special gesture. The security device can retrieve the recording of the last engaged key in this state. Recognizing that the last engaged key was the prime key, the security device can then delete the key registry of all registered user keys. The security device can confirm it has removed the key from the registry in state 207, for example by turning off the LED. Once the prime key is disengaged from the security device, the security device will revert back to the initialized state 201, to await the next command.

Once a key has been registered with the security device, it can be used to unlock the device. While the security device is in the initialized (default) state 201, a user key can tap the sensor located in the security device. The security device will be powered by the battery on the key, while the key is engaged. The security device can use the sensor to read the unique electronic identifier from the key, and can compare it to the list of identifiers in the memory. If the security device recognizes the unique electronic identifier, the security device can then temporarily enter the unlock state 210. In this state, the security device will be in the open position and may be coupled to or uncoupled from a portable electronic device. In certain embodiments, the security device will maintain state 210 for a temporary amount of time, such as 20 seconds, after which the security device will revert back to state 201 (i.e., it will revert to the closed position). In other embodiments, the security device can maintain state 210 for as long as the key is coupled to the sensor. For any state described above, the security device may time out if no further actions are taken after a predetermined time, such as about 15 or 20 seconds. Furthermore, the security device may alert a user to each state change, such as by flashing or otherwise implementing an LED.

In exemplary embodiments, the security device may be programmed by a separate computer system. In one example, a standard personal computer running key management software may be used. A hardware interface may be used to connect the computer to the security device. In one implementation, a cable can connect a RS-232 port on the security device with a USB port on the computer. In other implementations, the computer may also use an RS-232 port. In other implementations, other types of ports may be used, such as PCI express or firewire. In certain embodiments, the security device will only be programmed by the key management software while the prime key is simultaneously engaged. The key management software may require a user identifier and/or a password to operate. The key management software may contain or access a database file containing a list of keys. This way, the key management software can control which, if any, of these keys are registered with individual security devices. Thus, a key may be registered with a security device by selecting it from the database file using the key management software, by the physical engagement method described above, or by manually entering the key identifier associated with the key using the key management software. Removal of keys can similarly be effected using the key management software. In certain embodiments, the key management software may also be able to reset the security device to the factory state (to remove all keys, including the prime key, from being registered).

Embodiments of security devices described herein have many advantages over standard, physical key systems. The electronic nature of the key identifiers allows each security device to easily work with a plurality of different keys. Furthermore, there is no need to cut keys using a mechanical process. Thus, a nearly inexhaustible number of keys may quickly and easily be created electronically and used with the security devices described herein. Custom key systems are simple to implement, and reordering keys to be used with specific locks can be a simple matter. This allows a company or other to deploy the security device for a variety of purposes, as the security device is easily customizable. For example, a user or company may deploy one or more security devices to secure one or more portable electronic devices. Each security device has a memory that records at least two keys-one prime key, and at least one user key. Should a user key be lost, a new generic key (i.e., one that contains a unique electronic identifier but is not programmed with any lock) can be ordered from the manufacturer, and easily programmed to be usable with a security device as described above. In other embodiments, a security device may not be programmed with a prime key, but only one or more user keys. The user keys can be programmed to work with the security device by the manufacturer or supplier. Thus, the security device is only usable with the pre-programmed user keys. This system provides simplicity for an end user as it works much like a physical-key lock with no further programming required.

In certain embodiments, a plurality of security devices may be programmed to work with a “master key”. This master key can function similarly to a user key or prime key as described above, for more than one security device. An administrator can maintain the master key, and use it to replace any lost user keys for a security device in the plurality of security devices. Also, the administrator will be able to use the master key to lock/unlock any of the security devices. This can be useful for accessing company property that is secured by the master key system, for example. In some embodiments, each security device in a plurality of security devices may be programmed to only be usable with one or more master keys. Thus, all operations of the security devices can be centrally controlled by an administrator or any other holder of a master key.

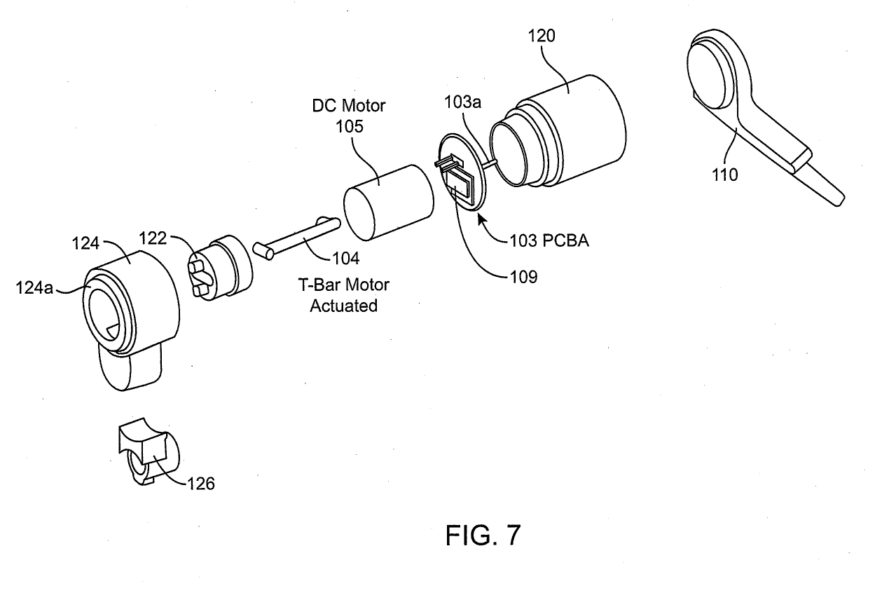

FIGS. 7-14B show various embodiments of security devices. FIG. 7 shows an expanded view of a security device according to an embodiment of the invention where an actuating member rotates an engagement member to effect locking or unlocking. FIG. 7 shows a system including a key 110, and a security device. The security device includes a first housing portion 124 and attached to a second housing portion 120. These may form the housing of the head of the security device. A cable ring 126 and a rubber gasket 124 are attached to the first housing portion 124. Anti-rotation pins 122 extend from a pin assembly, and a T-bar 104 passes through the pin assembly. A DC motor 105, which is an example of an actuating member, is coupled to the T-bar 104 and can turn it under appropriate circumstances. Electronics, including a controller 109, underneath the socket 103 can be in electrically communication with the DC motor 105.

Components associated with the engagement socket 103 control actuating member 105. When the sensor 103a receives an identifier from key 110, the controller 109 verifies that it is the correct identifier. It then sends an unlock signal to the actuating member 105, which then actuates and rotates the T-bar 104. The T-bar 104 can rotate relative to anti-rotation pins 122 so that the security device can be attached to or separated from a portable electronic device (as described above).

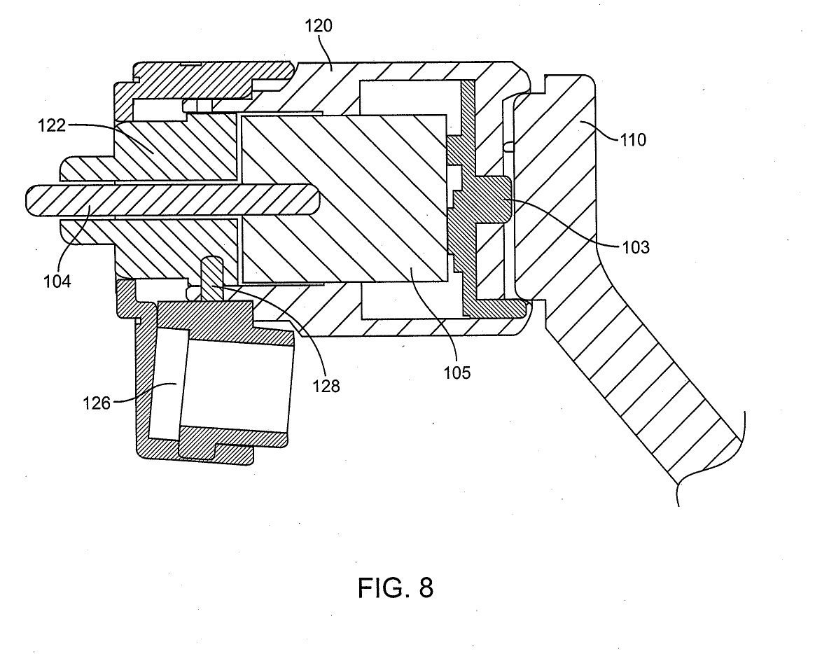

FIG. 8 shows a cross-sectional side view of a security device according to an embodiment of the invention. It shows the key 110 in contact with engagement socket 103. Engagement socket 103 is connected to actuating member 105, which is operatively coupled to T-bar 104.

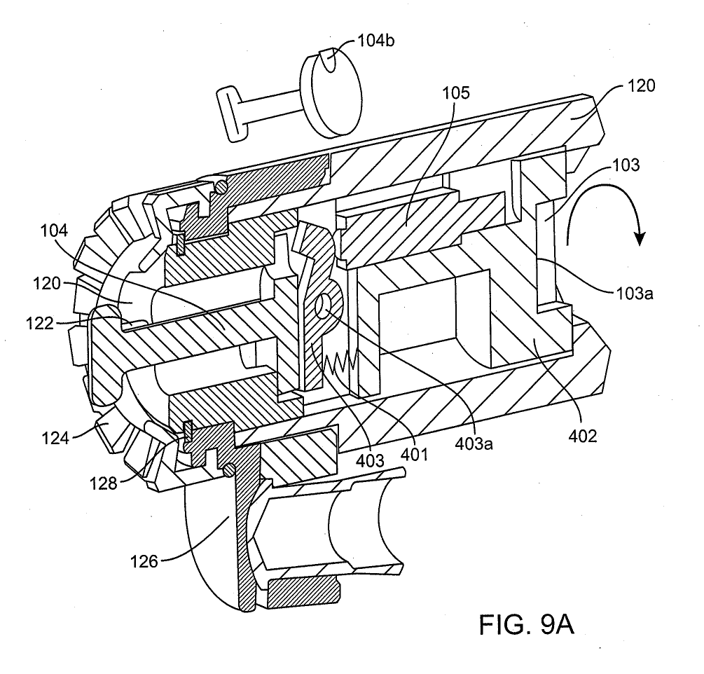

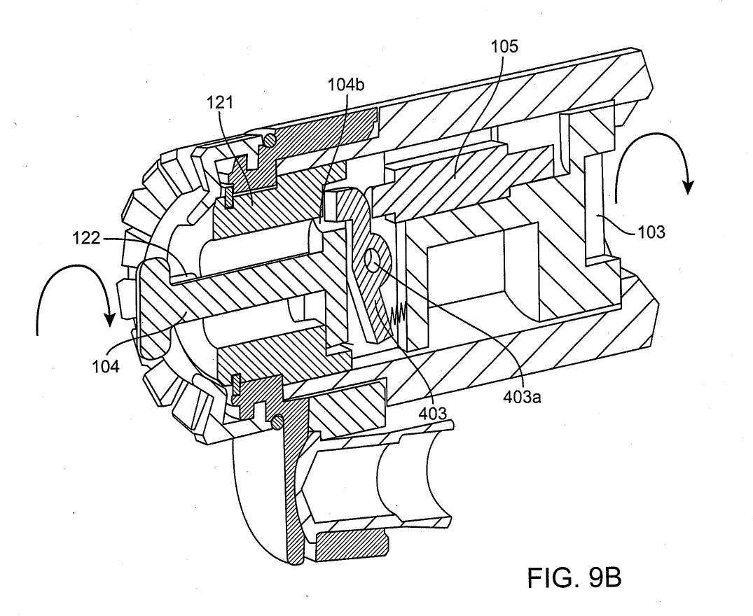

FIG. 9A shows a cross-sectional view of a security device in a locked configuration. The engagement member includes T-bar 104 and anti-rotation pins 122. The T-bar 104 can rotate relative to the anti-rotation pins 122. The anti-rotation pins 122 are held fixedly within upper cylinder 121, which can be fixedly connected to cable ring 126. In this embodiment, the T-bar 104 includes a plate at the end opposite the cross-member of the T-bar. The plate has a notch 104b in it. Latch 403 is configured to engage with the notch 104b. Latch 403 is configured to rotate about pivot 403a, which is fixedly attached to lock cylinder 402. A snap ring 128 can be disposed within the security device. The security device is configured to normally be in the locked configuration, where the latch 403 is held by spring 401 and is not engaged with the notch 104b. In this position, the T-bar 104 is spring loaded and will not rotate relative to the anti-rotation pins 122.

To rotate the T-bar 104 relative to the anti-rotation pins 122 (thus, unlocking the security device), a key (not shown) containing a unique electronic identifier engages with engagement socket 103 that is located within lock cylinder 402, so that the key is held proximate to sensor 103a. The key includes a power supply that will provide power to the security device. Engagement socket 103 contains a sensor 103a that is powered by the power supply on the key, and reads the unique electronic identifier from the key. A controller in the security device can compare the unique electronic identifier to a registry of identifiers in the security device memory. If the unique electronic identifier matches a listing in the registry, an unlock signal is sent by the controller to the actuating member 105. The actuating member 105 can be powered by the power supply included in the key, and can actuate after receiving the unlock signal. Actuating member 105 can comprise any suitable actuator (e.g., a linear actuator), such as a solenoid or motor.

Once activated, the actuating member 105 engages (such as by extending) the latch 403, which will rotate around pivot 403a, as in FIG. 9B. This will cause the latch 403 to physically couple to the T-bar 104 via notch 104b. While activated, the actuating member 105 can maintain the latch 403 in this physically coupled position. The latch 403 serves to physically couple the T-bar 104 to the lock cylinder 402. The lock cylinder 422, in turn, is physically coupled to a key. Thus, rotating the key will rotate the lock cylinder 422, which in turn will rotate the T-bar 104, unlocking the security device.

In embodiments of the invention, the actuating member 105 may only be actuated for a set amount of time (e.g., about 20 seconds), or it may continue to be actuated for the duration that the key is proximate to the sensor 103a. For example, in some embodiments, once the actuating member is deactivated, the spring 401 pushes the bottom portion of latch 403, which will rotate around pivot 403a. The rotation around pivot 403a will move the top portion of the latch 403 backward, thus disengaging the T-bar 104 from lock cylinder 402. If the T-bar 104 is spring activated, it can rotate back to the locked position. In this locked position, the T-bar 104 will no longer rotate, so that the security device will be securely coupled to a portable electronic device.

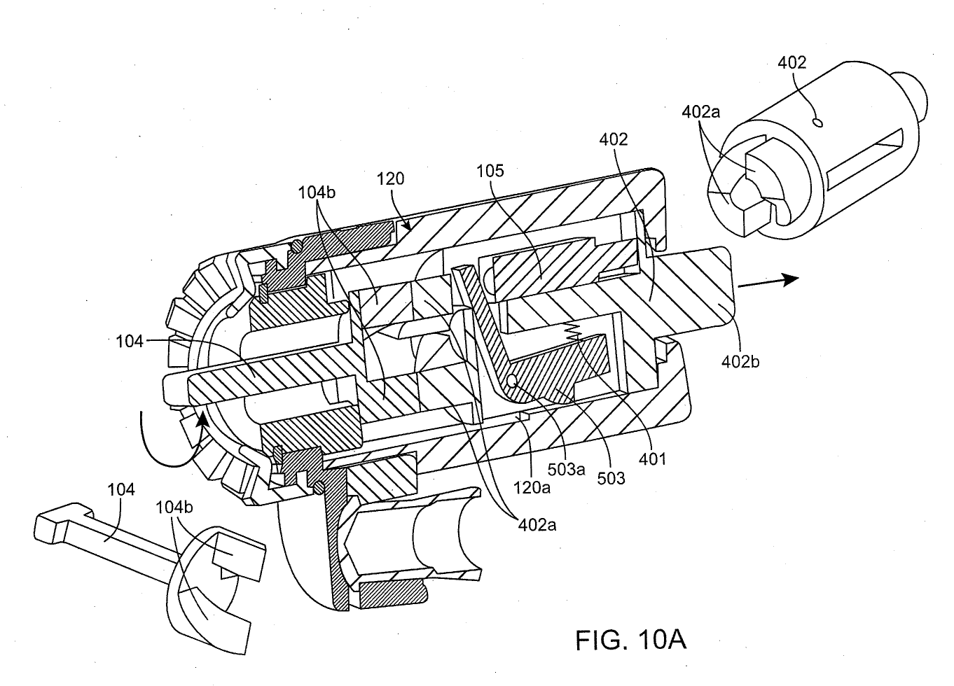

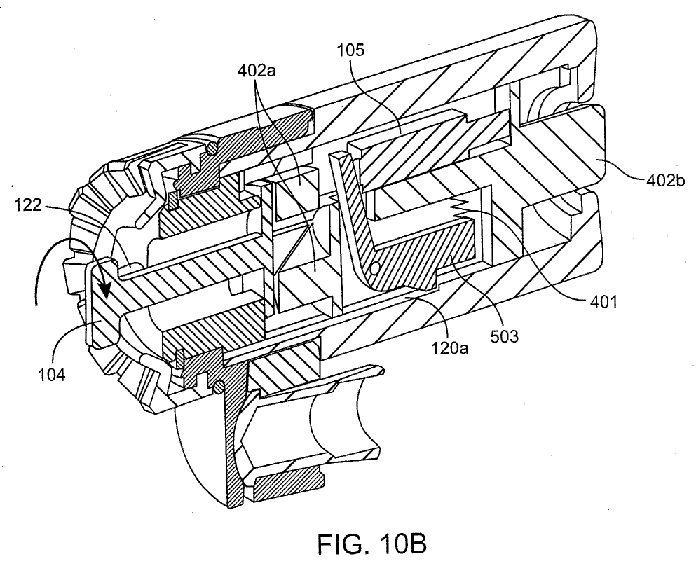

FIGS. 10A and 10B illustrate another embodiment of a security device. The security device includes a T-bar 104 and one or more anti-rotation pins 122. The T-bar 104 can rotate relative to the anti-rotation pins 122. In this embodiment, T-bar 104 includes a plate at the end opposite the cross member of the T-bar 104. The plate has a twisted ramp 104b extending in the direction opposite from the rest of the T-bar 104. This twisted ramp 104b is operatively coupled to a ramp 402a that extends out from the lock cylinder 402. In this embodiment, the lock cylinder 402 may slide axially within outer housing 120. The security device is placed in a locked configuration by pushing on button 402b, which normally extends out from the lock cylinder 402, axially toward the T-bar 104 as shown in FIG. 10B. This will slide the lock cylinder 402 in an axial directly towards the T-bar 104. Ramp 402a then converts the linear motion of the lock cylinder 402 into a rotational motion. This rotational motion rotates twisted ramp 104b. Thus, pushing on button 402b will rotate T-bar 104 relative to anti-rotation pins 122 (locking the security device).

Lock cylinder 402 contains a release latch 503. Release latch 503 is configured to rotate about pivot 503a, which is fixedly attached to lock cylinder 402. When the lock cylinder 402 slides towards the T-bar 104, the release latch moves in the same direction, until it engages with notch 120a in outer housing 120. Release latch is held in place by spring 401 and notch 120a while the security device is in the locked configuration, which prevents lock cylinder 402 from sliding away from the T-bar 104 (which would unlock the security device).

To unlock the security device, a key (not shown) containing the proper unique electronic identifier is placed proximate to a sensor in the security device. A controller within the security device can read the unique electronic identifier, and can send an unlock signal to the actuating member 105, which can activate (i.e., actuate) and extend as shown in FIG. 10A. Actuating member 105 can comprise any suitable actuator (e.g., a linear actuator), such as a solenoid or motor. When actuating member 105 extends, it pushes on a top portion of release latch 503, which will pivot around point 503a. The release latch can then disengage from notch 120a. In one implementation, the key can be physically coupled to lock cylinder 402, and the user can pull the lock cylinder 402 away from T-bar 104. In other implementations, the lock cylinder 402 can be spring loaded to slide away from the T-bar 104. With the lock cylinder moving away from the T-bar 104, the ramp 402a will disengage from T-bar 104, which can be spring loaded to rotate back into the unlocked configuration.

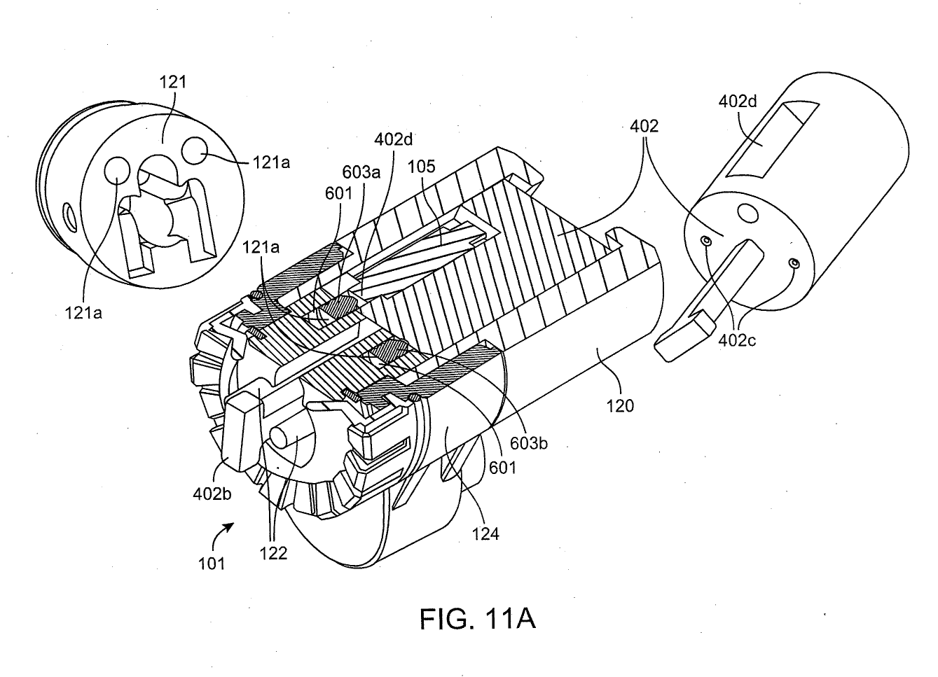

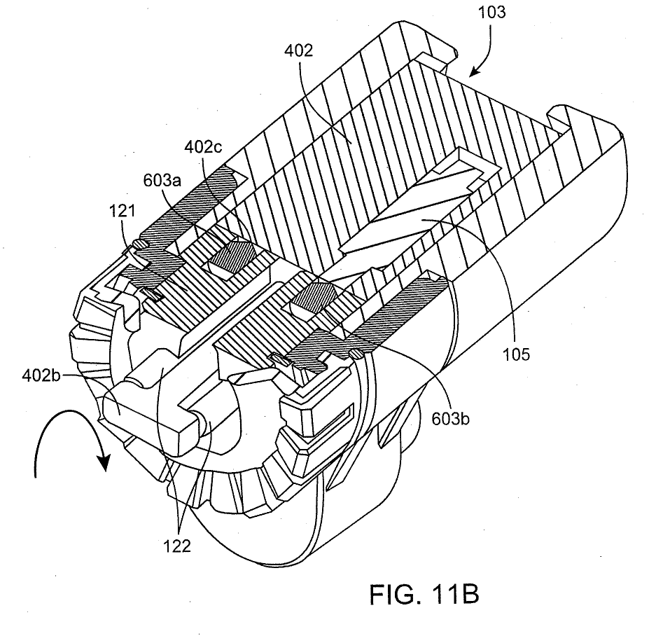

FIGS. 11A and 11B show locked and unlocked views, respectively, of another embodiment of a security device 101. In this embodiment, the T-bar 104 is formed as part of lock cylinder 402. The lock cylinder 402 and T-bar 104 may be formed of a single piece, or formed separately and coupled to each other by any suitable means (glue, welding, fasteners, etc). The lock cylinder 402 also contains one or more dimples 402c, on the same side of the lock cylinder as the T-bar 104. These dimples are configured to act as detents for one or more pins 603a and 603b located in holes 121a in upper cylinder 121. In exemplary embodiments, the lock cylinder contains two dimples 402c that can temporarily couple with pins 603a and 603b. One or more anti-rotation pins 122 are fixedly disposed within upper cylinder 121, which itself is fixedly coupled to outer housing 124. Actuating member 105 (comprising any suitable linear actuator such as a solenoid, motor, etc) is disposed within bore 402d located in locking cylinder 402. In the locked configuration of the security device 101, bore 402d is aligned with the hole 121a containing pin 603a. In this configuration, pin 603a extends from the upper cylinder 121 at least partially into the bore 402d, as shown in FIG. 11A. Pin 603a can be urged into bore 402d by a coiled compression spring 601 located within hole 121a. With pin 603a disposed in both upper cylinder 121 and lock cylinder 402, the T-bar 104 (as part of lock cylinder 402) is unable to rotate relative to anti-rotation pins 122. Thus the security device 101 remains in the locked configuration.

To unlock security device 101 as shown in FIG. 11B, a key (not shown) containing a unique electronic identifier engages the engagement socket 103 that is located within lock cylinder 402. While engaged, the key can be held proximate to a sensor in the engagement socket 103. The key includes a power supply that will provide power to the security device. The sensor can be powered by the power supply on the key, and reads the unique electronic identifier from the key. A controller in the security device will compare this unique electronic identifier to a registry of identifiers in the security device memory. If the unique electronic identifier matches a listing in the registry, the controller sends an unlock signal to actuating member 105. Power can then be transmitted from the key to actuate the actuating member 105. Once actuated, the actuating member 105 can extend toward the locking end of the security device to contact the pin 603a. This pushes pin 603a out until the actuating member extends to the shear line formed between the upper cylinder 121 and lock cylinder 402. In this position, the locking cylinder can rotate with respect to the anti-rotation pins 122 fixed within upper cylinder 121. When the key engages the engagement socket 103, rotation of the key will produce an approximately equivalent rotation of the T-bar 104. Thus, the T-bar 104 can be rotated until pin 603a engages a dimple 402c, and bore 402d is aligned with pin 603b, as shown in FIG. 11B. In certain embodiments, upon removal of the key while the security device 101 is in the unlocked configuration, the actuating member will revert back into a deactivated configuration (i.e., not extended), so that pin 603b will extend past the shear line into bore 402d. In this embodiment, the security device cannot be locked without re-engagement with a properly coded key. In other embodiments, actuating member will maintain the actuated state until the key is placed back in the locked position, so that the T-bar 104 can rotate freely while the security device is in the unlocked configuration.

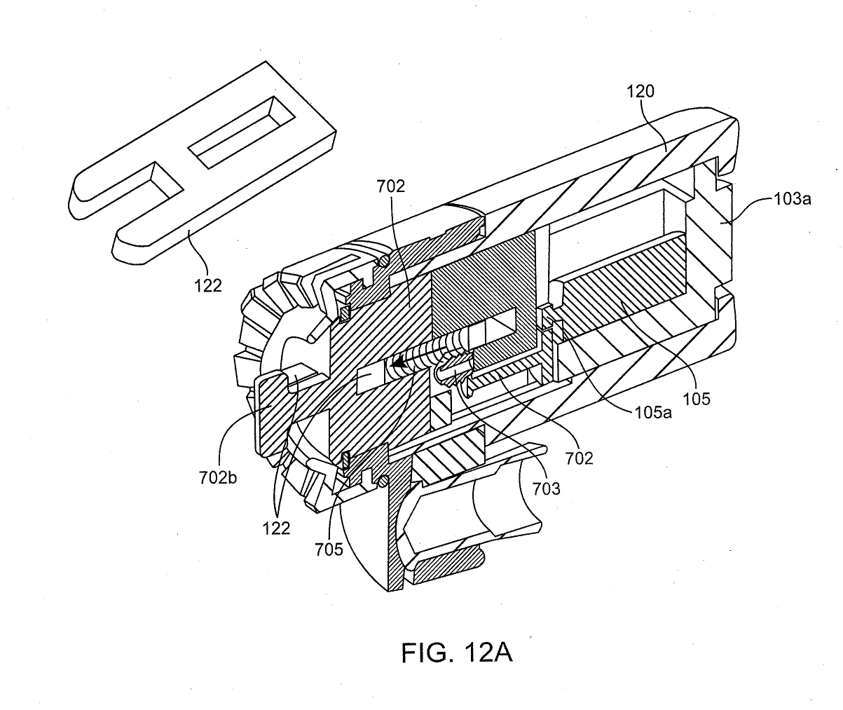

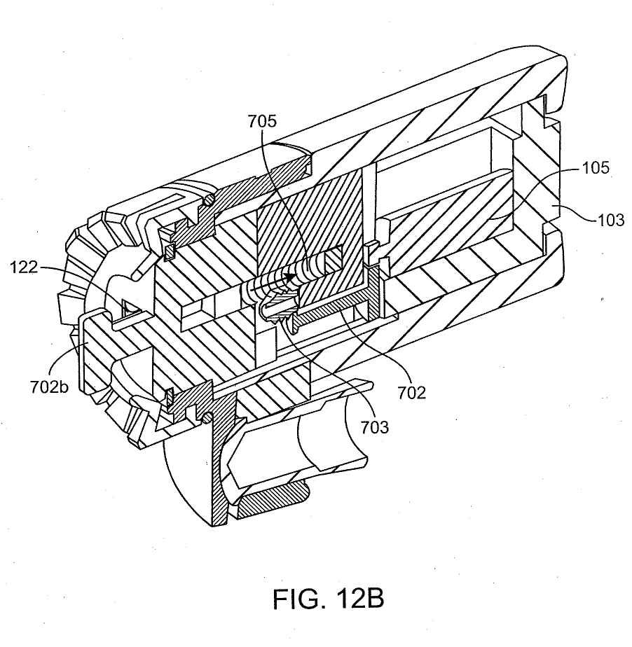

Referring to FIGS. 12A-12B, a security device is shown in which the T-bar 702b is fixed relative to outer housing 120, and the anti-rotation pins 122 can move laterally. A key (not shown) can be held proximate to sensor 103a. If the key contains a unique electronic identifier that is registered with the security device, a controller (not shown) within the security device can send an unlock signal to the actuating member 105. In this embodiment, once actuated, the actuating member 105 rotates gear 105a, which is physically coupled to reducing gear 702. Reducing gear is also physically coupled to worm gear 703, which in turn is physically coupled to a coil 705 attached to anti-rotation pins 122. Worm gear 703 is physically coupled to anti-rotation pins 122 such that rotation of worm gear 703 will thread the coil 705, moving the anti-rotation pins 122 in axial directions. Thus, rotation of gear 105a will cause the anti-rotation pins 122 to move back and forth in an axial direction. The actuating member can rotate gear 105a either clockwise or counter-clockwise, which will have the effect of moving anti-rotation pins 122 into or out of the housing of the security device. When the anti-rotation pins 122 are fully extended, as shown in FIG. 12A, the security device is in the locked configuration. When the anti-rotation pins 122 are fully retracted, as shown in FIG. 12B, the security device is in the unlocked configuration. Embodiments of the security device contemplate a greater number of gears than shown, for converting the rotational motion of actuating member 105 into lateral motion of anti-rotation pins 122. Other embodiments contemplate a fewer number of gears.

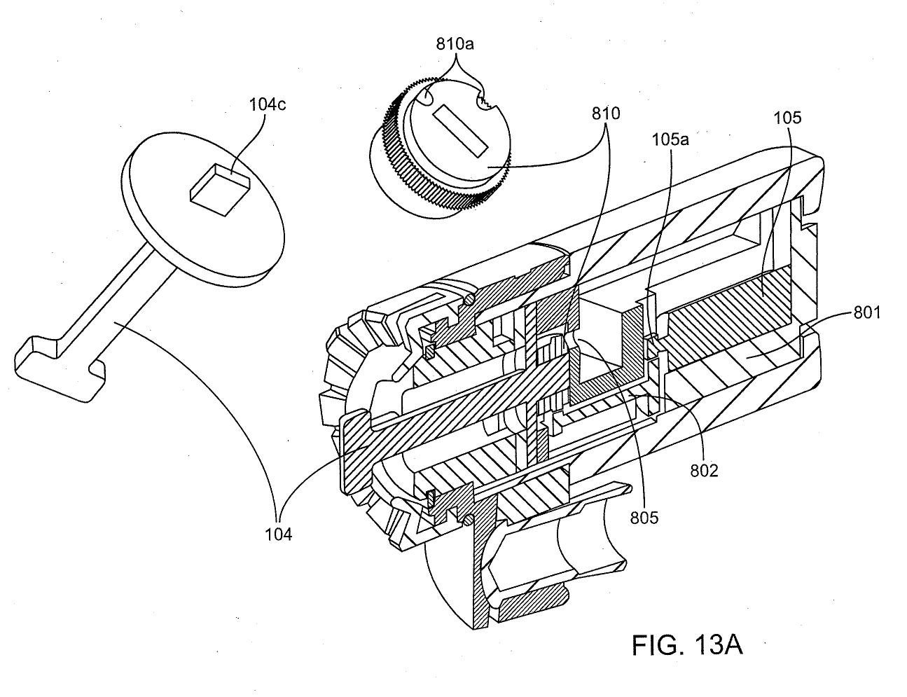

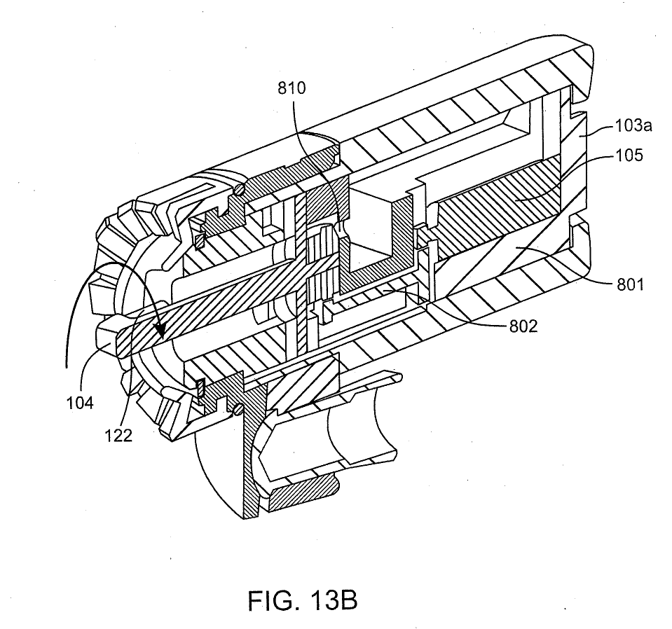

Referring to FIGS. 13A-13B, a security device is shown in which actuating member 105 can actuate (i.e., rotate) T-bar 104 for locking/unlocking of the security device. Actuating member 105 can comprise any suitable actuator that induces rotational motion on one end, such as a DC motor. This mechanical force can rotate the T-bar 104. T-bar 104 is physically coupled to gear 810, so that rotation of gear 810 creates a rotation in T-bar 104. Actuating member 105, when activated, can rotate gear 105a in either a clockwise or counter-clockwise direction, which will rotate reducing gear 802. Reducing gear 802 is physically coupled to gear 810. A sensor 805 disposed within lock cylinder 801 can read sensor marks 810 located on gear 810 to determine the rotational position of T-bar 104. In one embodiment, the sensor can count marks disposed radially around the gear 810 to determine the rotational position of T-bar 104. In another embodiment, the sensor can keep track of the rotation of the lock that has occurred previously, so that the current position of T-bar 104 is known. Sensor 805 is operatively coupled to a controller located within the security device, and the controller can use the sensor's readings to determine how far in any direction the bar 104 has been rotated. In certain embodiments, when a proper key is held proximate to a sensor 103a in the security device, the controller in the security device will determine the rotational position of the T-bar 104. The controller can calculate from the T-bar position both which direction to then rotate T-bar 104, and how much rotation is necessary to either position the security device in the locked configuration (as shown in FIG. 13A), or the unlocked configuration (as shown in FIG. 13B). The controller can then send an unlock signal to actuating member 105, which will actuate in order to rotate the T-bar 104 the required amount of rotation as determined by the controller.

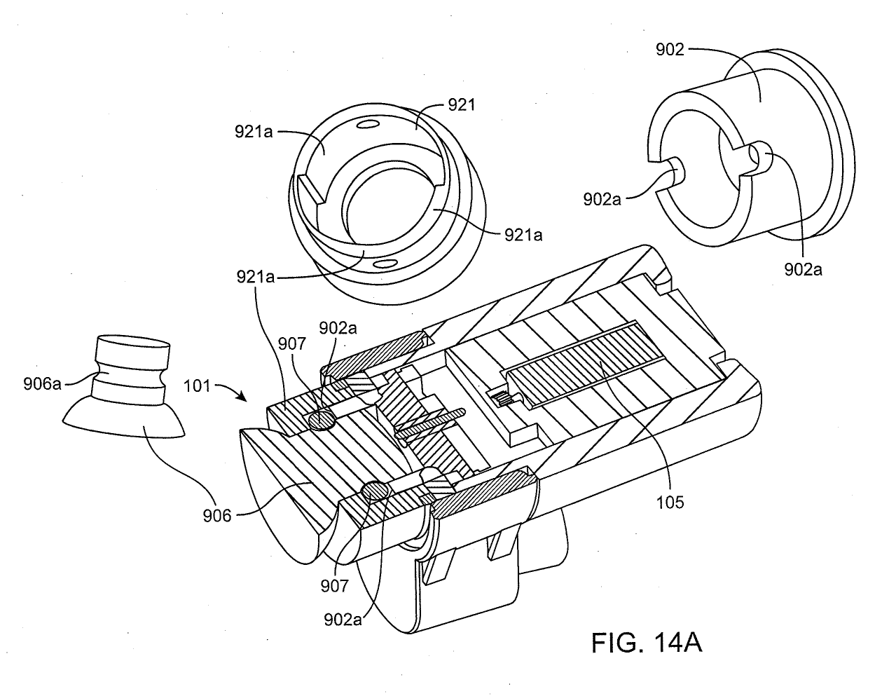

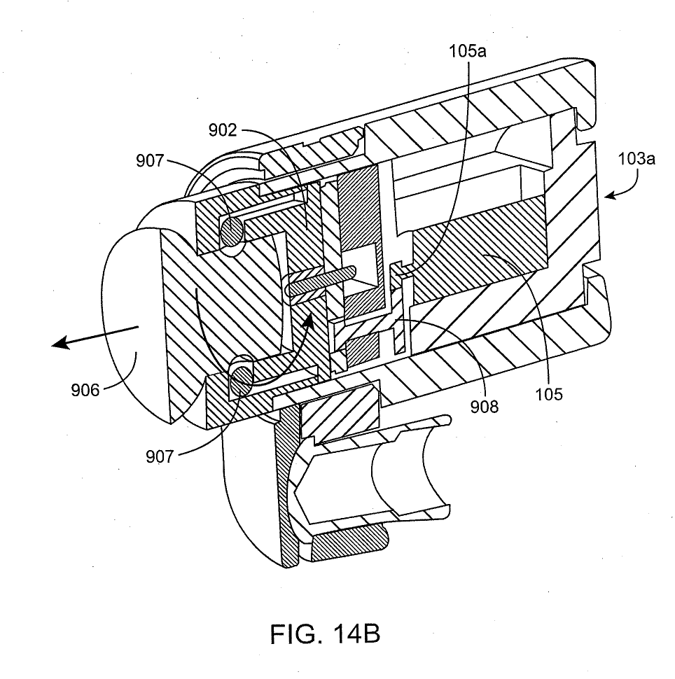

FIGS. 14A-14B show an alternative embodiment of a security device. FIG. 14A shows a horizontal cross-sectional view, and FIG. 14B shows a vertical cross-sectional view. In this embodiment, the security device 101 can couple to anchor 906. The anchor 906 can be an example of an engagement member. Anchor 906, in turn, can be secured on one end to a security slot in the housing of a portable electronic device (not shown), either permanently or removably. The security device 101 can physically couple to the opposite end of anchor 906, in order to secure the portable electronic device to an stationary object. Exemplary anchors and corresponding security slots are described in U.S. patent application Ser. No. 6,360,405, issued on Mar. 26, 2002, which is herein incorporated by reference in their entirety for all purposes.

While physically coupled to security device 101, the anchor can be held within inner sleeve 902. Ball bearings 907 can be located in pockets 902a of the inner sleeve. Within the pockets 902a, the ball bearings 907 can be retained between upper cylinder 921 and anchor 906. Ball bearings 907 can engage with channel 906a formed within anchor 906. Thus, while held in place by ball bearings 907, anchor 906 cannot be removed from security device 101 as shown in FIG. 14A.

To unlock the security device 101, a key containing a proper unique electronic identifier can be held proximate to sensor 103a. A controller (not shown) within the security device can read the unique electronic device identifier, and can send an unlock signal to the actuating member 105. Actuating member 105 can then actuate upon receiving the unlock signal. Actuating member 105 can comprise any suitable actuator that induces rotational motion on one end, such as a DC motor. Once actuated, actuating member 105 can rotate gear 105a, which is physically coupled to reducing gear 908. Reducing gear is physically coupled to worm gear 703, which in turn is physically coupled to gearing on inner sleeve 902. Rotation of gear 105a can rotate inner sleeve 902 within upper cylinder 921 by the predetermined amount (in one example, by approximately 90 degrees). Upper cylinder 921 includes a reducing radius inner wall 921a. In the locked configuration of the security device 101, a thicker portion of reducing radius inner wall 921a holds ball bearings 907 against anchor 906. In the unlocked configuration of security device 101, a thinner section of reducing radius inner wall 921a holds ball bearings 907 against anchor 906. In this configuration, the ball bearings 907 will have more space while still within pockets 902a, and can retract or be pushed away from anchor 906, as shown in FIG. 14B. With the ball bearings 907 retracted, anchor 906 has clearance to disengage from security device 101. To lock the security device, the above process can act in reverse.

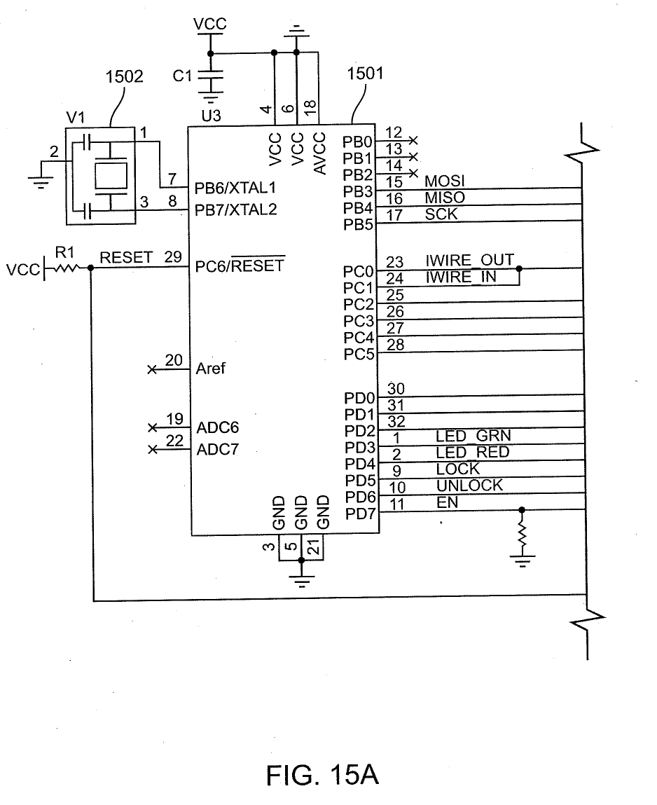

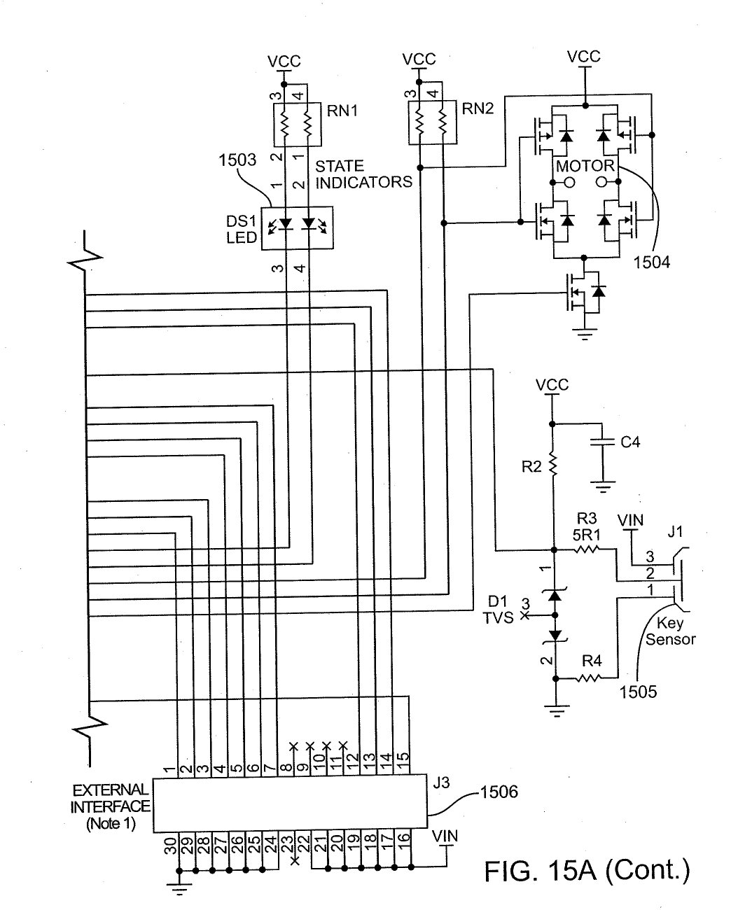

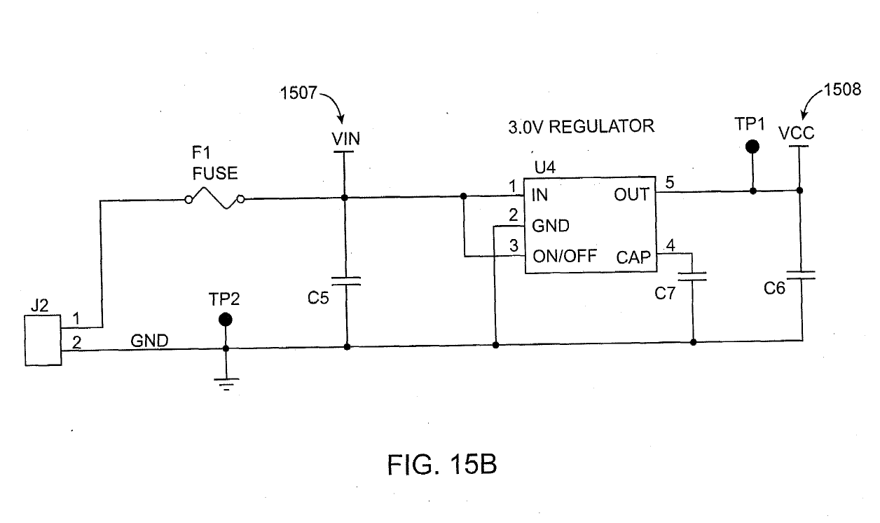

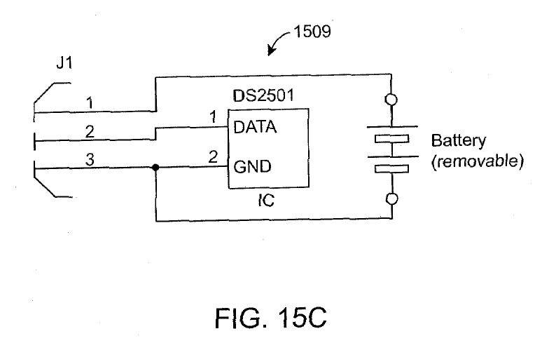

An exemplary circuit diagram of an embodiment of a security device is shown in FIGS. 15A-15B, and an exemplary circuit diagram of an embodiment of a key containing a unique electronic identifier is shown in FIG. 15C. Referring to FIG. 15A, a clock 1502 can provide a clock signal to controller die 1501. Controller die 1501 can include the memory, and can be programmed to perform the identifier comparisons and other controller functionality described herein. One or more indicator LEDs 1503 are electrically connected to controller die 1501. Controller die 1501 can send an unlock signal to driver circuit 1504. The driver circuit 1504 can actuate a motor or other actuating member (not shown), such as to unlock the security device. At the factory, the security device can be programmed through connector 1506. For example, connector 1506 can connect to a computer or other suitable device for programming. In certain implementations, connector 1506 can be sealed off after the security device is manufactured, to prevent tampering. Sensor 1505 can read at least one identifier from a key 1509, as shown in FIG. 15C. FIG. 15B shows further circuitry within the security device. Input 1507 can connect to the VIN connection from sensor 1505. In some embodiments, the VIN connection can supply power from a connected key 1509. Output 1508 can connect to the VCC of the circuit of FIG. 15A, to supply power to the rest of the security device while a key 1509 is connected. It is understood that other suitable circuits could alternatively be used in embodiments of the invention, and embodiments of the invention are not limited to the specific implementation shown in FIGS. 15A-15C

In exemplary embodiments of security devices, the corresponding key includes an integrated circuit an identifier and a power source such as a battery or capacitor. In certain embodiments, the identifier may comprise at least one identifier. In certain embodiments, the identifier may comprise at least one unique electronic identifier. The security device may not contain its own power source, and can be configured to receive all power from the key. The integrated circuit can comprise an iButton®, and the engagement socket within the security device includes a sensor that comprises an iButton® sensor. In some embodiments, the key can comprise a universal serial bus (USB) drive, which can couple to the security device by means of a USB port. The key may contain additional functionality, such as functioning as a standard USB drive or music player. In other embodiments, the unique electronic identifier may be stored on the key in a card with a magnetic strip or other types of integrated circuits. In additional implementations, the key identifier may be derived from the biometrics of the user, and may be read by the lock using an appropriate sensor mechanism. Alternatively, the unique electronic identifier may be transmitted from the key to the lock using radio frequencies such as with RFID, other wireless signals such as Bluetooth, or other suitable methods.

In certain embodiments, when they key is held proximate to the sensor of the security device, the key will be physically engaged to the engagement socket within the security device. The key may contain notches that physically couple to matching protrusions in the engagement socket, or vice versa. In other embodiments, the key can magnetically couple with the engagement socket. In exemplary embodiments, the key is physically engaged to the engagement socket so that, while the security device is in the unlocked configuration, rotation of the key will compel an equivalent rotation of the engagement member of the security device.

In an exemplary embodiment, the actuating element comprises electromechanical means such as a direct current (DC) motor. In some embodiments, the actuating element may be a rotary motor. In some embodiments, the actuating element may be a linear motor. In other embodiments, the actuating element may comprise magnetic means, a piezoelectric actuator, micro-electromechanical systems (MEMS), a solenoid, or other suitable transducers or actuators. In the embodiments described herein, the engagement member includes an engagement member in the form of a T-bar. However, the bar may take any suitable alternative shape, including an L-bar configuration.

Embodiments of security inventions as described herein contain advantages. Replacing lost or stolen keys is an inexpensive and simple process, as any generic key with a unique electronic identifier can be programmed to be usable with the security device. Keys may be simple and inexpensive to produce. No locksmith is required to replace keys, which provides enhanced security. A key may be registered with more than one security device, and vice versa. Group management of a plurality of security devices is more efficient, as locks may be programmed in bulk by computer. An administrator has greater control over access to the security devices, as keys may be programmed to be used for specific groups of devices, and guest keys can be provisioned for a limited amount of uses. The security devices can be programmed with only hardware (i.e., no computer interface needed) by means of the prime key. This allows even technologically unsophisticated users to access the expanded capabilities of the devices described herein.

Embodiments of the designs described herein are advantageously of a compact size. This allows them to easily be carried by a user, increasing the ability to effectively be used in securing a portable electronic device. Furthermore, embodiments can have reduced weight due to the small size. This makes the security device both easier to attach to portable electronic devices, without damaging the housing. No changes need to be made to existing portable electronic devices, as embodiments can work with existing security slots. Thus, embodiments of security devices described herein can provide enhanced functionality and security within existing security frameworks.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

Moreover, any one or more features of any embodiment of the invention may be combined with any one or more other features of any other embodiment of the invention, without departing from the scope of the invention.

All patent applications, patents, and publications mentioned above are herein incorporated by reference in their entirety for all purposes. None is admitted to be prior art.

What is claimed is:

1. A security device for use with a portable electronic device having a housing and an aperture, the security device comprising:
a sensor configured receive at least one identifier stored in a key;
a controller coupled to the sensor;
an actuating member operatively coupled to the controller, wherein the actuating member is configured to actuate after receiving an unlock signal from the controller; and
at least one of a stabilizing element and an engagement member,
wherein the actuating member is capable of selectively operatively coupling to the stabilizing element or the engagement member.

2. The security device of claim 1, wherein the controller is configured to send the unlock signal to the actuating member after receiving the at least one identifier.

3. The security device of claim 2, wherein the key includes a power source, and further wherein the sensor is configured to transmit power from the power source to the actuating member after receiving the at least one identifier.

4. The security device of claim 1, wherein the security device includes both the engagement member and the stabilizing element.

5. The security device of claim 1, wherein the actuating member comprises a solenoid.

6. The security device of claim 1, wherein the actuating member comprises a motor.

7. The security device of claim 6, wherein the motor comprises one of a linear motor or a rotary motor.

8. The security device of claim 6, wherein the motor comprises a DC motor.

9. The security device of claim 1, further comprising a cable, wherein the cable is configured to secure the portable electronic device to a stationary object.

10. The security device of claim 1, wherein the actuating member is capable of actuating the engagement member.

11. The security device of claim 10, wherein the actuating member is configured to produce a mechanical force that rotates the engagement member.

12. The security device of claim 11, wherein the engagement member is in the form of a T-bar.

13. The security device of claim 10, wherein the actuating member is configured to extend the stabilizing element into the aperture.

14. The security device of claim 1, wherein the actuating member is configured to selectively couple the engagement member when the key is proximate to the sensor.

15. The security device of claim 1, further comprising a memory, wherein the memory is configured to store at least one identifier.

16. A security system comprising:
the security device of claim 1; and
the key.

17. The security system of claim 16, wherein the key further comprises a power source, and wherein the security system further comprises the portable electronic device.

18. The security apparatus of claim 17 wherein the engagement member is in the form of a T-bar.

19. A method comprising:
obtaining a security device comprising a housing, and a sensor, at least one of a stabilizing element and an engagement member, and a controller coupled to the housing;
inserting at least a portion of the engagement member into an aperture in a portable electronic device housing, thereby securing the security device to the portable electronic device housing;
placing a key proximate to the sensor;
moving one or more of the engagement member or the stabilizing element; and
separating the security device from the portable electronic device housing.

20. The method of claim 19, wherein moving one or more of the engagement member or the stabilizing element includes moving the engagement member.

21. The method of claim 19, wherein the engagement member rotates.

22. The method of claim 19 wherein placing the key proximate to the sensor comprises placing the key in contact with the sensor, and wherein the security device includes both the engagement member and the stabilizing element.

23. The method of claim 22, wherein the actuating member is configured to retract the one or more anti-rotation pins upon activation, and further wherein rotating at least a portion of the engagement member comprises rotating the slot engagement member relative to the aperture.
